(19) United States
(12) Patent Application Publication
(10) Pub. No.: US 2012/0319030 A1
(43) Pub. Date: Dec. 20, 2012

(54) MULTIFUNCTIONAL COLLOID NANO COMPOSITE DERIVED FROM NUCLEOPHILIC SUBSTITUTION-INDUCED LAYER-BY-LAYER ASSEMBLY IN ORGANIC MEDIA AND FABRICATION OF THE SAME

(76) Inventor: Jin Han CHO, Seoul (KR)

(21) Appl. No.: 13/526,750

(22) Filed: Jun. 19, 2012

(30) Foreign Application Priority Data
Jun. 20, 2011 (KR) 10-2011-0059702

(51) Int. Cl. H01F 1/42; B05D 7/00; B82Y 30/00

(52) U.S. Cl. 252/62.54; 252/62.51 R; 252/62.59; 427/180; 977/774; 977/773

(57) ABSTRACT

Disclosed is a multifunctional colloidal nanocomposite derived from nucleophilic substitution-induced layer-by-layer assembly in organic media. The multifunctional colloidal nanocomposite includes: silica colloids coated with aminopropyltrimethoxysilane; and a plurality of nanoparticle layers highly densely adsorbed onto the coated silica colloids. The multifunctional colloidal nanocomposite has a highly dense multilayer structure in which 2-bromo-2-methylpropionic acid (BMPA)-stabilized quantum dot nanoparticles and an amine-functionalized polymer are adsorbed onto silica colloids using a nucleophilic substitution reaction-based layer-by-layer assembly method. Due to this structure, the multifunctional colloidal nanocomposite can be dispersed in various organic solvents, including polar and nonpolar organic solvents. In addition, the multifunctional colloidal nanocomposite can be utilized in various applications, such as nonvolatile memory devices, magnetic cards, and optical display films due to its strong magnetic and photoluminescent properties, high crystallinity and functional stability, and good superhydrophobicity. Further disclosed a method for preparing the multifunctional colloidal nanocomposite.

### BACKGROUND OF THE INVENTION

1. Field of the Invention

The present invention relates to a multifunctional colloidal nanocomposite. More specifically, the present invention relates to a multifunctional colloidal nanocomposite that is derived from nucleophilic substitution (NS)-induced layer-by-layer (LbL) assembly in organic media, and a method for preparing the same. The multifunctional colloidal nanocomposite of the present invention can be well-dispersed in polar organic solvents as well as nonpolar organic solvents and has excellent optical, magnetic and superhydrophobic properties.

2. Description of the Related Art

Functional nanocomposites, including magnetic particles (MPs) and/or quantum dots (QDs), have attracted considerable attention due to their potential applications in nonvolatile memory devices, biomedical imaging, magnetic cards, and optical display films.

In particular, adsorption of combinations of these functional nanoparticles onto large colloidal substrates can have specific technological merits for tuning the optical and magnetic properties of their constituents, and the materials can be used in emerging technologies, such as magneto-optical sensing or separation techniques.

The successful preparation of such colloidal composites is achieved by synthesizing the nanoparticles (MPs and QDs) in nonpolar organic solvents, rather than in aqueous media, with the help of stabilizers, such as oleic acid. This ensures a uniform size and high crystallinity. After synthesis, the stabilizers must be exchanged to permit immobilization of the nanoparticles onto colloidal substrates and be selected to minimize chemical or physical damage that might destroy the nanoparticles' unique properties. Nanoparticles should be densely packed onto colloidal substrates without agglomeration to achieve high performance. For example, the solution pH, nature of hydrophilic ligands, and nanoparticle size can significantly affect the quantum yield of QDs and the magnetic properties of MPs synthesized in water. These qualities also affect the nanoparticle dispersion stability and the quantity of nanoparticles adsorbed onto the substrates.

The use of colloidal nanocomposites in various organic media requires that they can be well-dispersed in nonpolar solvents, such as toluene or hexane. Although efforts have been made to prepare hybrid nanocomposites that include MPs and QDs, previous methods have mainly been applicable to aqueous solutions only.

Generally, magnetic quantum dot nanocomposites were prepared by the sol-gel method. The use of sol-gel methods in the design of structurally and compositionally complex nanocomposites using organic solution processes, particularly in nonpolar solvents such as toluene, chloroform, or hexane, is difficult.

Core-shell colloids prepared by electrostatic layer-by layer (LbL) assembly displayed magnetic luminescent properties upon introduction of electrostatically charged Fe₃O₄ and CdTe nanoparticles. However, the electrostatic adsorption of functional nanoparticles onto colloids usually results in a low packing density for each component layer due to electrostatic repulsion between the same charged species. To their advantage, such approaches can be used in aqueous media but are not suitable for use in nonpolar solvents or polar organic solvents.

Thus, there is a need to develop multifunctional colloids that are well-dispersed in polar organic solvents as well as nonpolar solvents.

### SUMMARY OF THE INVENTION

It is, therefore, a first object of the present invention to provide a multifunctional colloidal nanocomposite that is well-dispersed in nonpolar organic solvents as well as polar solvents, and displays strong magnetic and photoluminescent properties, high crystallinity and functional stability, and good superhydrophobicity.

It is a second object of the present invention to provide a method for preparing the multifunctional colloidal nanocomposite in which nanoparticle multilayers with photoluminescent and magnetic properties are formed on silica colloids by a nucleophilic substitution reaction-based layer-by-layer assembly.

To achieve the first object of the present invention, there is provided a multifunctional colloidal nanocomposite including: silica colloids coated with aminopropyltrimethoxysilane (APS); and a plurality of nanoparticle layers highly densely adsorbed onto the APS-coated silica colloids, wherein the nanoparticles are selected from 2-bromo-2-methylpropionic acid (BMPA)-stabilized quantum dot (BMPA-QD) particles, 2-bromo-2-methylpropionic acid (BMPA)-stabilized iron oxide (BMPA-Fe₃O₄) particles, poly(amidoamine) (PAMA) nanoparticles and mixtures thereof, and the nanoparticle layers have a laminate structure of (BMPA-Fe₃O₄/PAMA)ₙ, (BMPA-QD/PAMA)ₙ, (BMPA-QD/PAMA/BMPA-Fe₃O₄)ₙ, (BMPA-Fe₃O₄/PAMA/BMPA-QD)ₙ, (BMPA-QD/PAMA/BMPA-Fe₃O₄/PAMA)ₙ or (BMPA-Fe₃O₄/PAMA/BMPA-QD/PAMA)ₙ, where n is an integer from 1 to 9, on the APS-coated silica colloids.

In an embodiment of the present invention, the quantum dot nanoparticles may be nanoparticles of a CdSe/ZnS core-shell quantum dot compound.

To achieve the second object of the present invention, there is provided a method for preparing a multifunctional colloidal nanocomposite, the method including: (a) preparing silica colloids coated with aminopropyltrimethoxysilane (APS); and (b) sequentially adsorbing a plurality of kinds of nanoparticles in high density onto the APS-coated silica colloids to final a plurality of nanoparticle layers, wherein the nanoparticles are selected from 2-bromo-2-methylpropionic acid (BMPA)-stabilized quantum dot (BMPA-QD) particles, 2-bromo-2-methylpropionic acid (BMPA)-stabilized iron oxide (BMPA-Fe₃O₄) particles, poly(amidoamine) (PAMA) nanoparticles and mixtures thereof, and the nanoparticle layers have a laminate structure of (BMPA-Fe₃O₄/PAMA)ₙ, (BMPA-QD/PAMA)ₙ, (BMPA-QD/PAMA/BMPA-Fe₃O₄)ₙ, (BMPA-Fe₃O₄/PAMA/BMPA-QD)ₙ, (BMPA-QD/PAMA/BMPA-Fe₃O₄/PAMA)ₙ or (BMPA-Fe₃O₄/PAMA/BMPA-QD/PAMA)ₙ, where n is an integer from 1 to 9, on the APS-coated silica colloids.

In an embodiment of the present invention, in step (b), the nanoparticle layers may be formed on the APS-coated silica colloids by layer-by-layer assembly based on a nucleophilic substitution reaction between the bromo groups of the 2-bromo-2-methylpropionic acid nanoparticles and the amine groups of the poly(amidoamine) to bond the 2-bromo-2-methylpropionic acid to the poly(amidoamine).

In another embodiment of the present invention, in step (b), the plurality of nanoparticle layers may be formed by layer-by-layer assembly based on a nucleophilic substitution reaction between the bromo groups of the 2-bromo-2-methylpropionic acid nanoparticles and the amine groups of the poly(amidoamine) to bond and adsorb the 2-bromo-2-methylpropionic acid to the poly(amidoamine).

In another embodiment of the present invention, in step (b), the BMPA-QD or BMPA-Fe₃O₄ nanoparticles may be dispersed in toluene as a solvent and adsorbed to the APS-coated silica colloids to form a BMPA-QD or BMPA-Fe₃O₄ nanoparticle layer on the APS-coated silica colloids.

In another embodiment of the present invention, in step (b), the PAMA nanoparticles may be dispersed in ethanol and adsorbed to the BMPA-QD or BMPA-Fe₃O₄ nanoparticle layer to form a PAMA nanoparticle layer.

In another embodiment of the present invention, the method may further include (c) dipping the APS-coated silica colloids formed with the plurality of nanoparticle layers thereon in a mixed solution of perfluorotrichlorosilane and hexane.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically depicts a colloidal nanocomposite coated with (BMPA-nanoparticles/PAMA)ₙ multilayers bonded via nucleophilic substitution in organic media, and a method for the preparation of the colloidal nanocomposite;

FIG. 2 shows SEM images of APS-SiO₂ colloids coated with (BMPA-QD_{green}/PAMA)ₙ multilayers for (a) n=1, (b) 3, (c) 5, (d) 7 and (e) 9, and (f) a diameter change of (BMPA-QD_{green}/PAMA)ₙ multilayer-coated silica colloids measured with increasing layer number;

FIG. 3 shows (a) photoluminescence (PL) images and (b) UV-vis and PL spectra of (BMPA-QD/PAMA)-2-coated silica colloids in toluene;

FIG. 4 shows (a) PL intensity and (b) change in degree of PL intensity of (BMPAQD_{green}/PAMA)₉ and (PAH/MAA-QD_{green})₉-coated colloids as a function of time;

FIG. 5 shows SEM images of (a) (BMPA-Fe₃O₄/PAMA)₅-coated silica colloids and (b) (PAH/octakis-Fe₃O₄)₅-coated silica colloids;

FIG. 6 shows magnetic curves of (PAMA/BMPA-Fe₃O₄)₉-coated colloids measured at (a) 300 K and (b) 5 K, and (c) temperature dependence of the colloids under a magnetic field of 150 Oe;

FIG. 7 shows photographic and PL spectra of a blending solution of two different kinds of colloids coated with APS-SiO₂/(BMPA-Fe₃O₄/PAMA/BMPA-QD_{red}/PAMA)₃ and APS-SiO₂/(BMPA-QD_{green}/PAMA)₃, respectively, showing that the blending solution can display reversible optically tuned properties under magnetic control;

FIG. 8 shows images showing the water contact angles of silica colloidal films (a) without and (b) with adsorbed BMPA-stabilized nanoparticles;

FIG. 9 shows TEM images and PL intensity spectra of (a) blue (diameter=4.5 nm), (b) green (diameter=5.4 nm) and (c) red (diameter=5.6 nm) quantum dot (CdSe/Zns) particles stabilized with oleic acid, respectively; and

FIG. 10 shows magnetic curves of (PAH/octakis-Fe₃O₄)₉-coated colloids measured at (a) 300 K and (b) 5 K, and (c) temperature dependence of the colloids under a magnetic field of 150 Oe.

### DETAILED DESCRIPTION OF THE INVENTION

The present invention will now be described in detail.

The present invention provides a multifunctional colloidal nanocomposite highly densely coated with iron oxide (Fe₃O₄) nanoparticles and CdSe (core)/ZnS (shell) quantum dot nanoparticles via nucleophilic substitution (NS) reaction-based layer-by-layer (LbL) assembly in organic solvents, and a method for preparing the colloidal nanocomposite.

The present invention is characterized in that hybrid nanocomposite colloids are prepared by alternate deposition of (i) superparamagnetic Fe₃O₄ (i.e., BMPA-Fe₃O₄) and photoluminescent CdSe/ZnS nanoparticles (i.e., BMPA-QDs), stabilized by 2-bromo-2-methylpropionic acid (BMPA) with bromo groups, in toluene; and (ii) an amine-functionalized poly(amidoamine) dendrimer (i.e., PMMA) in alcohol, on silica colloid particles via a nucleophilic substitution (NS) reaction between the bromo groups of BMPA nanoparticles and the amine groups of PAMA.

The colloidal composite could be well-dispersed in various organic media, such as alcohol and toluene, depending on the outermost layer deposited. The colloids displayed much stronger superparamagnetic and photoluminescent (PL) properties than those prepared from electrostatic LbL assembly, and the colloids displayed reversible optical tuning memory under magnetic control. Furthermore, the densely packed rugged surface morphology formed from nanoparticle layers easily induced superhydrophobicity, with water contact angles exceeding 150°.

The present invention will be explained in more detail with reference to the following examples. However, these examples serve to provide further appreciation of the invention and it will be obvious to those with ordinary knowledge in the art that they are not intended to limit the scope of the invention.

### EXAMPLES

(1) Poly(amidoamine) (PAMA) dendrimer, oleic acid, 2-bromo-2-methylpropionic acid (BMPA), CdO, zinc acetate, 1-octadecene, selenium, sulfur powder, and trioctylphosphine were purchased from Sigma Aldrich and were used in the following examples.

(2) To evaluate the magnetic and optical properties of multifunctional colloidal nanocomposites, Fourier transform infrared (FTIR) spectra were taken with a FTIR-200 spectrometer (JASCO Corporation). For this measurement, BMPA-Fe₃O₄, PAMA dendrimer, and (PAMA/BMPA-Fe₃O₄)ₙ multilayers were deposited onto NaCl substrates.

UV-vis and PL spectra were measured with a Perkin-Elmer Lambda 35 UV-vis spectrometer and a fluorescence spectroscope (Perkin-Elmer LS 55), respectively. The PL spectra of (PAMA/BMPA-QD)ₙ multilayers were measured at an excitation wavelength of λₑₓ≈300 nm.

A QCM device (QCM200, SRS) was used to investigate the mass of material deposited into flat gold electrodes. The resonance frequency of the QCM electrodes was ca. 5 MHz. The adsorbed mass of PAMA, BMPA-Fe₃O₄, and octakis-Fe₃O₄, Δm_{A}, can be calculated from the change in QCM frequency, ΔF, according to the Sauerbrey equation: ΔF (Hz)=−56.6×Δm_{A}, where Δm_{A} is the mass change per quartz crystal unit area, in mg/cm².

The magnetism of (PAMA/BMPA-Fe₃O₄), multilayers was measured by a superconducting quantum interference device (SQUID, MPMS5) magnetometer.

### Preparative Example 1

### Preparation of BMPA-Stabilized Photoluminescent Quantum Dot Nanoparticles

In the case of photoluminescent QDs (CdSe/ZnS), 38.5 mg of CdO, 700 mg of zinc acetate, 17.6 mL of oleic acid, and 15 mL of 1-octadecene were put into a 250 mL round flask. The mixture was heated to 150° C. with N₂ gas blowing and further heated to 300° C. to form a clear solution of Cd(OA)₂ and Zn(OA)₂. At this temperature, 31 mg of Se powder and 128.2 mg of S powder both dissolved in 2 mL of trioctylphosphine were quickly injected into the reaction flask. After the injection, the temperature of the reaction flask was set to 300° C. for promoting the growth of QDs, and it was then cooled to room temperature to stop the growth. QDs were purified by adding 20 mL of chloroform and an excess amount of acetone (3 times).

After this purification, 3.34 wt % of BMPA was added to 40 mL QD solution for the stabilizer exchange from oleic acid to BMPA and then was heated at 40° C. for 2 h to prepare BMPA-stabilized BMPA-QDs (CdSe/ZnS).

### Comparative Example 1

### Preparation of MAA-Stabilized Quantum Dot Nanoparticles

In the case of mercaptoacetic acid (MAA)-QDs, 15 mg/mL of oleic acid-stabilized QDs in 5 mL of toluene was mixed with 10 mL of aqueous solution containing 100 mg/mL of MAA at 45° C. The MAA-QD obtained from phase transfer was precipitated by the addition of excess ethanol solvent and centrifugation at 6000 rpm for 6 min. The precipitated MAA-QDs were redispersed in aqueous solution at pH 9. The concentration of MAA-QD was adjusted to 1 mg/mL.

### Preparative Example 2

### Preparation of BMPA-Stabilized Iron Oxide Nanoparticles

Oleic acid-stabilized Fe₃O₄ of about 12 nm size was synthesized in toluene. BMPA (1.336 g, 8 mmol) was added to 40 mL of Fe₃O₄ solution for the stabilizer exchange from oleic acid to BMPA and then was heated at 40° C. for 2 h to prepare BMPA-Fe₃O₄.

### Comparative Example 2

### Octakis-Stabilized Iron Oxide Nanoparticles

Octakis-Fe₃O₄ was prepared by the stabilizer exchange from oleic acid to octakis. In this case, a total of 100 mg of oleic acid-Fe₃O₄ was dissolved in 7.5 mL of toluene, and 750 mg of excess octakis was dissolved in 7.5 mL of pH 9 water.

### Preparative Example 3

### Buildup of Nanoparticle Multilayers by Nucleophilic Reaction-Based Layer-by-Layer Assembly

The concentration of PAMA, BMPA-QD, and BMPA-Fe₃O₄ solutions was fixed to 1 mg/mL in organic media (ethanol for PAMA and toluene for BMPA-Fe₃O₄).

(1) First, 100 mL of a concentrated dispersion (6.4 wt %) of negatively charged 600 nm silica colloids was diluted to 0.5 mL with deionized water. After fast centrifugation (8000 rpm, 5 min) of colloidal solution, supernatant water was removed, and then 1 mg/mL of aminopropyltrimethoxysilane (APS) ethanol solution was added to silica colloidal sediment followed by ultrasonication and sufficient adsorption time. Excess APS was removed by three centrifugations (8000 rpm, 5 min)/wash cycles to prepare APS-coated silica colloids.

(2) For the preparation of multilayers onto APS silica colloids, 0.5 mL of BMPA-QD (or BMPA-Fe₃O₄) (1 mg/mL) in toluene was added, and after deposition during 10 min, the excess BMPA-QD (or BMPA-Fe₃O₄) was removed by three centrifugations as mentioned above to form highly densely coated BMPA-QD (or BMPA-Fe₃O₄) layers.

Then, 0.5 mL of PAMA (1 mg/mL) in ethanol was deposited in high density onto the BMPA-QD-coated colloids using the same conditions.

If needed, the BMPA-QD (or BMPA-Fe₃O₄) layers may be further formed on the PAMA layers, and furthermore PAMA layers may be again formed. The above process was repeated until the desired layer number was deposited on the colloidal silica.

### Preparative Example 4

### Preparation of Superhydrophobic Films

The hydrophobization of the PAMA/BMPA-QD/PAMA/Fe₃O₄ multilayer-coated silica colloidal films was performed by dipping the films in n-hexane solution containing 1H,1H,2H,2H-perfluorotrichlorosilane (6 mg/mL) for 20 min and then followed by mild baking at 70° C. for 30 min under vacuum.

### Experimental Example 1

### Evaluation of Optical Properties

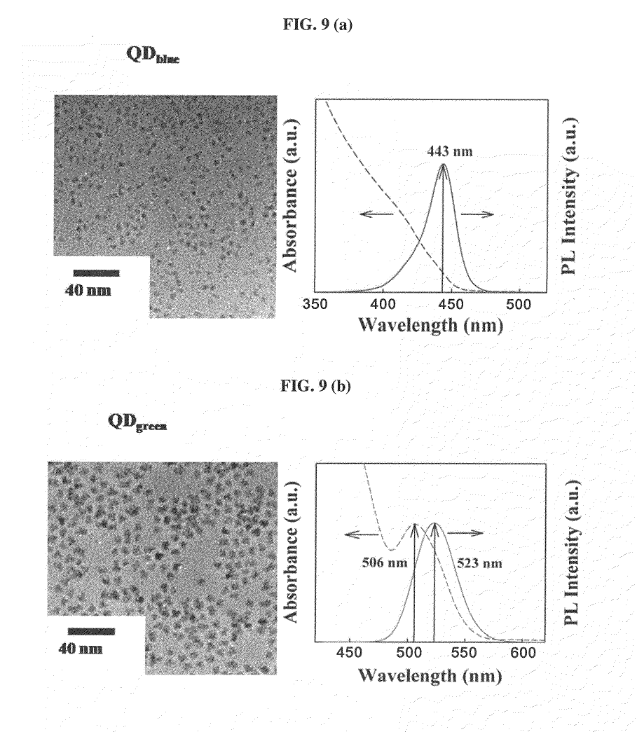

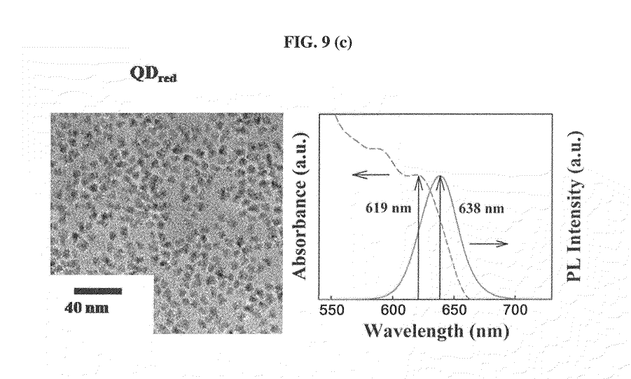

Oleic acid-stabilized CdSe/ZnS QD nanoparticles displaying blue (PL λₘₐₓ=445 nm), green (PL λₘₐₓ=523 nm), and red (PL λₘₐₓ=638 nm) emission bands were prepared in toluene (see FIG. 9). The initial oleic acid stabilizers were replaced with BMPA via ligand exchange to produce BMPA-QDs.

The relative quantum yields of the blue, green, and red BMPA-QDs were measured to be 45% (relative to 9,10-diphenylanthracene), 45% (relative to coumarin 545), and 42% (relative to Rhodamine 101), respectively.

The bromo groups of BMPA stabilizers can undergo NS reaction with amino groups to covalently bond the BMPA-QDs to the amine-functionalized material, such as PAMA or aminopropyltrimethoxysilane (APS).

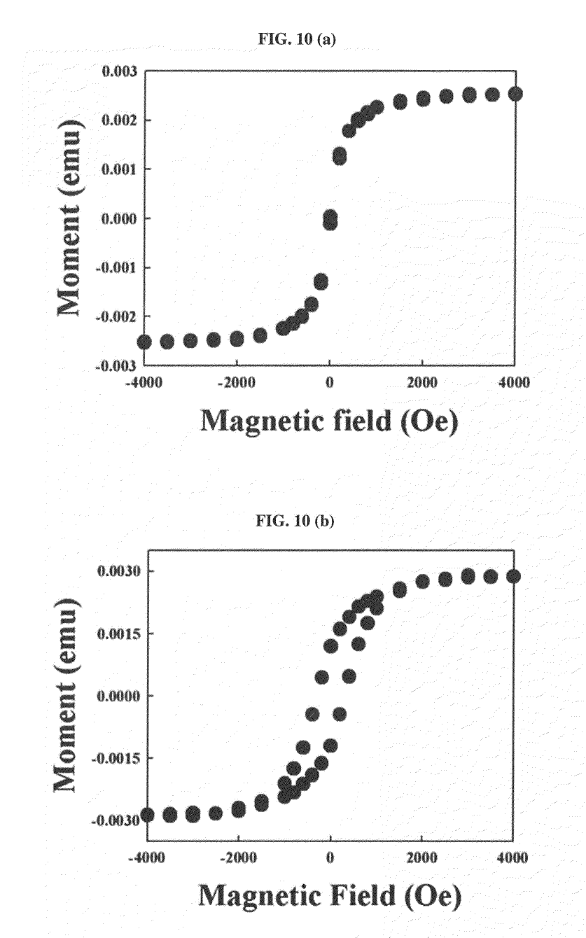

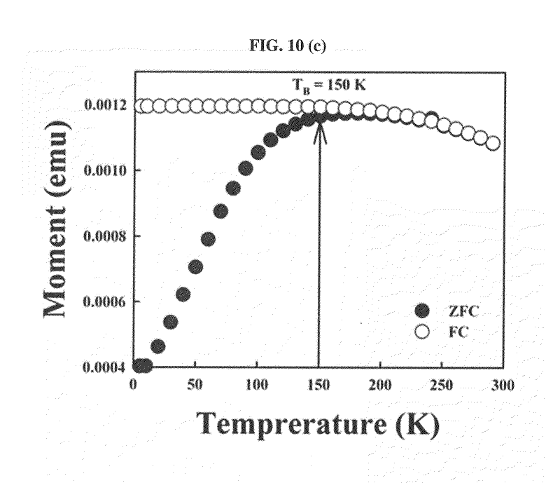

Covalent bonding was confirmed by Fourier transform infrared (FTIR) spectroscopy of the PAMA/BMPA-QD multilayer films prepared on the Si wafer substrates (FIG. 10). The CH symmetric deformation (1380 cm⁻¹) of CH₃ groups as well as C═O vibration modes (1710 and 1410 cm⁻¹) were observed in BMPA-QDs. This observation implies the presence of BMPA stabilizers onto the QD because BMPA has —CH₃ and —COOH. The PAMA dendrimer has absorbance peaks caused by the characteristic C═O stretching (1629 cm⁻¹) of amide groups and N—H bend (1550 cm⁻¹) of primary amines, —NH₂ (FIG. 10). On the other hand, the FT-IR spectrum of PAMA/BMPA-QD multilayers displayed the peak broadening in the range of 1589-1500 cm⁻¹, and furthermore, the strong peaks at 1450, 1190, and 1100 cm⁻¹ are caused by secondary aliphatic amines occurring from a nucleophilic substitution reaction between primary amine and bromo groups.

On the basis of these results, BMPA-QDs_{green} were first deposited onto an APS-coated silica colloid (APS-SiO₂) surface, using 600 nm diameter colloidal particles, and PAMA was subsequently adsorbed onto the BMPA-QD_{green}-coated colloids.

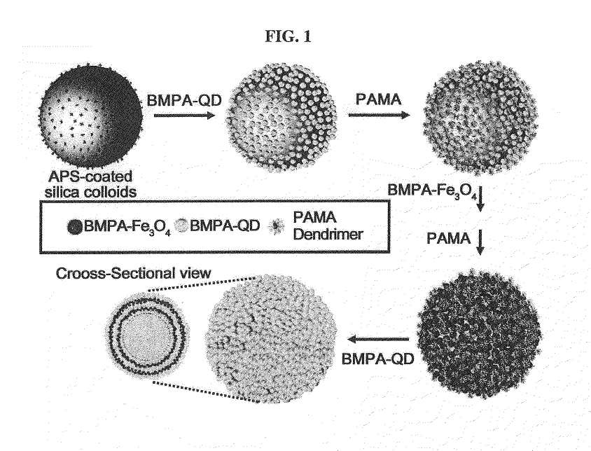

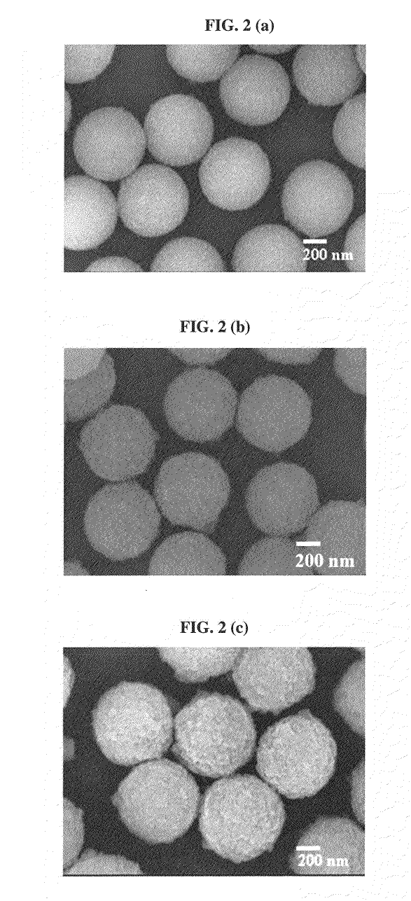

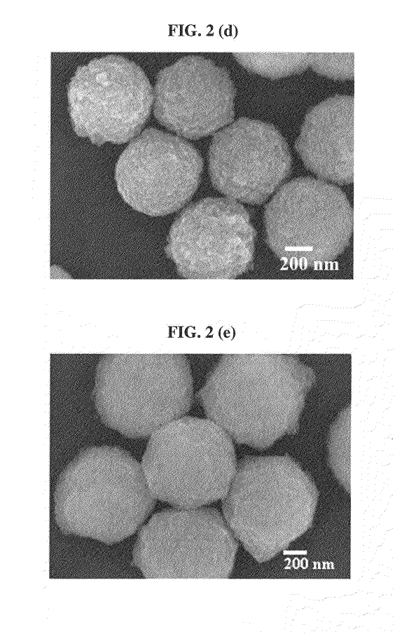

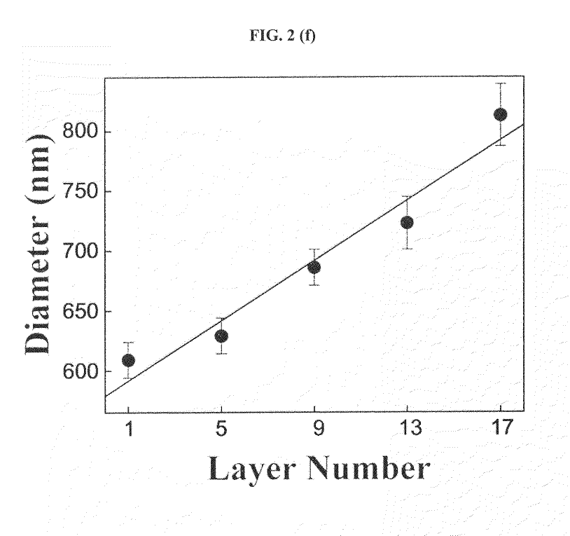

FIG. 1 schematically depicts the colloidal nanocomposite coated with (BMPA nanoparticle/PAMA)ₙ multilayers bonded via nucleophilic substitution in organic media. As shown in FIG. 1, a densely coated nanoparticle layer was obtained from adsorption of a single BMPA-QD_{green} layer. Increasing the bilayer number (n) from 1 to 9 produced a multilayer-coated colloid layer with a more rugged and densely coated structure and without aggregation of the colloids. Although the number density of BMPA-QDs_{green} on the colloidal substrate could not be determined precisely, the frequency change of a quartz crystal microbalance (QCM) contacted with a flat substrate permitted approximation of the quantity of BMPA-QD_{green} adsorbed onto 600 nm sized colloids.

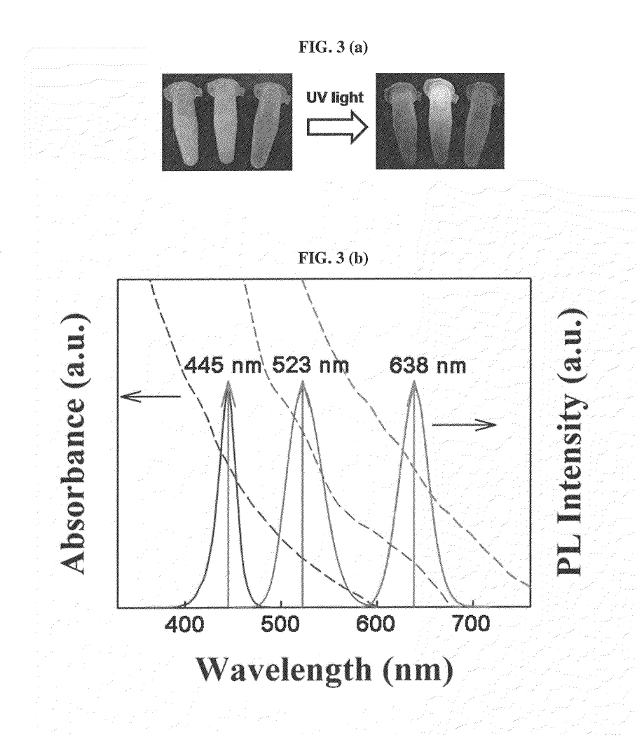

The average frequency change of the QCM, in going from the PAMA layer to the BMPA-QD_{green} layer, was 221 Hz (3904 ng/cm²). The densities of the 4 nm diameter CdSe QD core and the 1 nm diameter ZnS QD shell were 5.81 and 3.89 g/cm³, respectively. Therefore, the number of BMPA-QDs_{green} adsorbed onto the colloids was calculated to be about 13,700 per silica colloid. Additionally, the diameter of the functionalized colloids increased from 609 to 813 nm as the bilayer number (n) increased from 1 to 9 (FIG. 20. The nanocomposite colloids in chloroform displayed strong PL behavior with a negligible red shift in the optical spectra relative to the spectra of the oleic acid-stabilized QDs in the same solvent (FIG. 3).

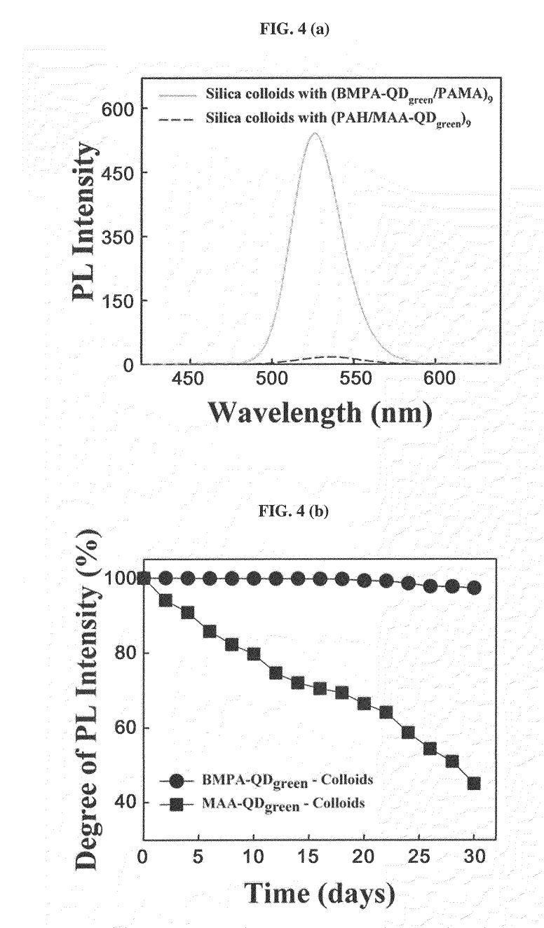

In Comparative Example 1, negatively charged CdSe/ZnS QDs stabilized by mercaptoacetic acid (MAA), abbreviated MAA-QD, via ligand exchange were prepared. Mltilayered films were then prepared by LbL growth of the MAA-QD_{green}/cationic poly(allylamine hydrochloride) (PAH) on the anionic SiO₂ colloids via electrostatic deposition. The relative quantum yield of MAA-QD_{green} was measured to be 9%. Although the solution concentration and deposition layer number (9 layers) of the MAA-QD films were identical to those of the BMPA-QD films, the surface coverage of MAA-QDs on the colloids was extremely low due to electrostatic repulsion between the same charged MAA QDs_{green} (FIG. 4).

These observations were in stark contrast to the trends observed for the (BMPA-QD_{green}/PAMA)ₙ-coated SiO₂. The PL intensity of (BMPA-QD_{green}/PAMA)₉-coated colloids, therefore, was much higher than that of the (PAH/MAA-QD_{green})₉-coated colloids mainly due to the relatively high quantum yield of BMPA-QD_{green} and their dense surface coverage per layer (FIG. 4a). Remarkably, the PL intensity (BMPA-QD_{green}/PAMA)ₙ multilayer-coated SiO₂ colloids was nearly unchanged during storage under ambient conditions (in the dark in ambient air) for more than 1 month, whereas the PL intensity of (PAH/MAA-QD_{green})ₙ-coated colloids decreased notably depending on the storage time (FIG. 4b). These results suggest that the hydrophobic character of the BMPA-QD layers deposited in nonpolar solvents prevented PL quenching by hydrolysis and oxidation under ambient conditions and preserved the original PL behavior of the QDs in the multilayer films.

### Experimental Example 2

### Evaluation of Magnetic Properties

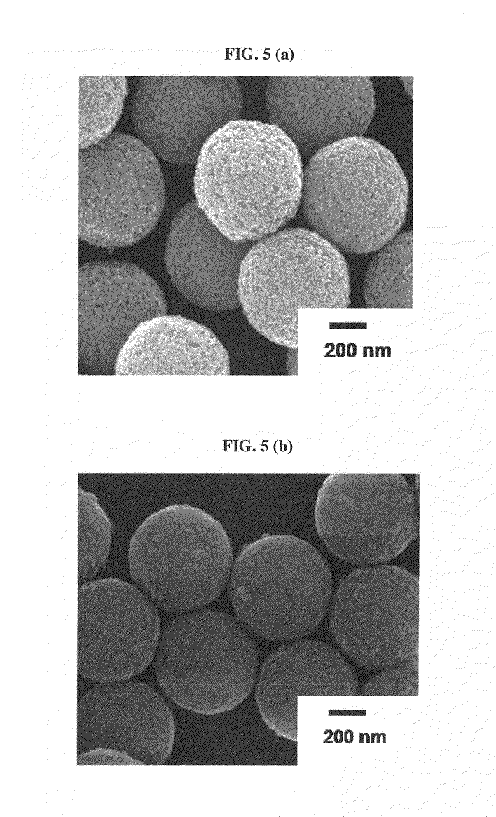

The BMPA-Fe₃O₄ nanoparticles prepared by ligand exchange of BMPA on oleic acid-stabilized 12 nm diameter Fe₃O₄ nanoparticles were also deposited on the APS-coated silica colloids to introduce magnetic properties (FIG. 5a).

The number of adsorbed BMPA-Fe₃O₄ particles per bilayer was measured to be approximately 9,800 on the colloid, based on the following information.

The adsorbed mass (Δm) of BMPA-Fe₃O₄ on the flat substrate calculated from QCM measurements was 4064 ng/cm², the density of Fe₃O₄ was 5.1 g/cm³, and the nanoparticle number density was 8.69×10¹¹/cm². The quantity of nanoparticles adsorbed onto a curved surface was assumed to be comparable to that adsorbed onto a flat surface.

The number of adsorbed BMPA-Fe₃O₄ nanoparticles on the colloid layer was significantly higher (3,328 per bilayer) than that of water-dispersible octakis-Fe₃O₄ prepared by stabilizer exchange from oleic acid to the negatively charged octakis (FIG. 5b) in Comparative Example 2.

The electrostatically charged nanoparticles imposed limitations on the nanoparticle packing density in the lateral dimensions due to electrostatic repulsion between neighboring nanoparticles at a given solution pH (pH>7 for the octakis-Fe₃O₄ dispersion). Although the packing density of the octakis-Fe₃O₄ could be increased by decreasing the charge density on the nanoparticles (at a solution pH<7), the low charge density caused aggregation of the nanoparticles in solution. Aggregation made it difficult to control the preparation of stable nanocomposite colloidal coatings.

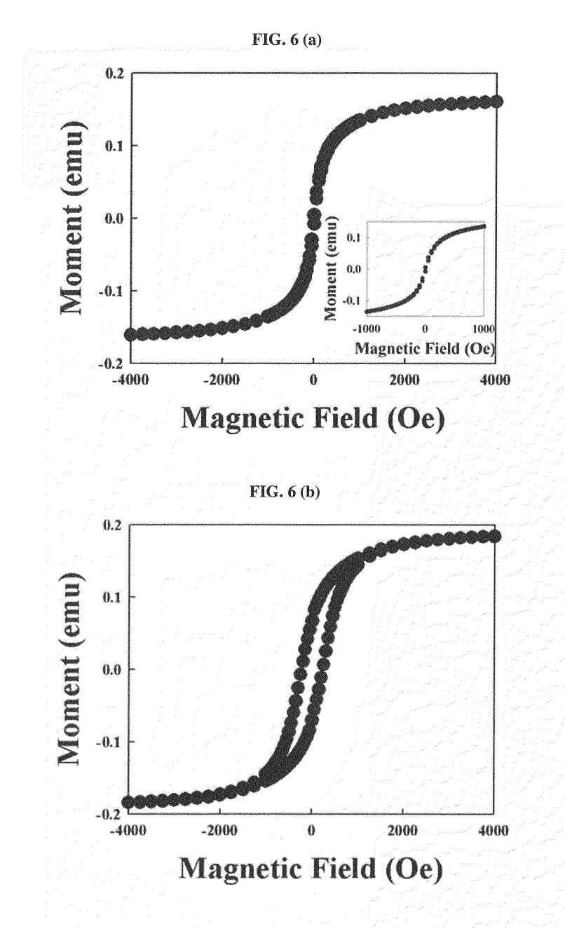

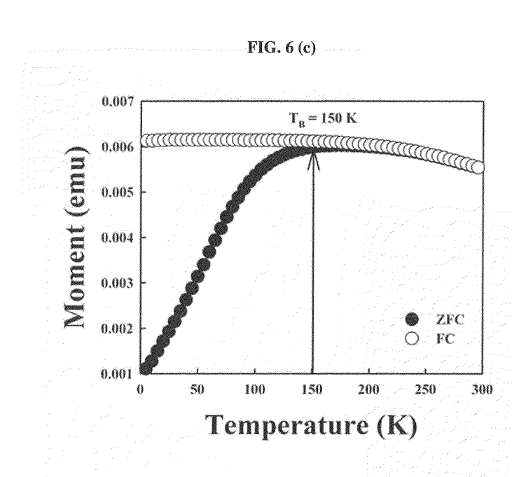

Magnetic characterization of the APS-SiO₂/(BMPA-Fe₃O₄/PAMA)₉ was performed using a superconducting quantum interference device (SQUID) magnetometer in the field range from −6000 to +6000 Oe. The magnetization curves of the multilayered films measured at room temperature (T=300 K) were reversible without coercivity, remanence, or hysteresis, suggesting typical superparamagnetic behavior (FIG. 6a). These results were confirmed by recording the magnetization at 1 min intervals at low applied fields (see the inset of FIG. 6a). On the other hand, at liquid helium temperature (T=5 K), the magnetization flipping properties of the BMPA-Fe₃O₄ revealed frustrated superparamagnetic properties. That is, the magnetization curves acquired a loop shape with distinct separation between the two sweeping directions typically observed for ferromagnets. The coercivities (H_{c}) and remanences (Mᵣ) were measured to be 225 Oe and 0.0673 emu, respectively (FIG. 6b). FIG. 6c shows the temperature dependence of the magnetization of the resulting BMPA-Fe₃O₄-coated colloids, from 300 to 5 K, under an applied magnetic field of 150 Oe. The blocking temperature, which began to deviate between zero-field cooling (ZFC) and field-cooling (FC) magnetization states, was fixed at approximately 150 K. These results indicate that the nanocomposite colloids coated with BMPA-Fe₃O₄ maintained their inherent superparamagnetic properties.

In contrast, the magnetic colloids prepared by electrostatic LbL-assembled cationic (poly-(allylamine hydrochloride) (PAH)/anionic octakis-Fe₃O₄)₉ had notably low degrees of saturated magnetization compared to the (PAMA/BMPA-Fe₃O₄)₉-coated colloids (FIG. 10). This low magnetization resulted mainly from the small quantity of octakis-Fe₃O₄ nanoparticles adsorbed onto the colloids.

### Experimental Example 3

### Evaluation of Magneto-Optical Properties

Because both the highly photoluminescent BMPA-QDs and the strongly superparamagnetic BMPA-Fe₃O₄ nanoparticles could be successfully adsorbed onto colloids via NS reaction without producing colloidal aggregation, the combination of these two nanoparticles may produce magneto-optically separable colloids that are stable in various organic media, including polar (alcohol) and nonpolar (toluene or chloroform) solvents.

BMPA-QD_{red} and BMPA-Fe₃O₄ nanoparticles were sequentially deposited onto APS-coated silica colloids to produce APS-SiO₂/(BMPA-Fe₃O₄/PAMA/BMPA-QD_{red}/PAMA)₃. The resultant magnetic luminescent colloids were mixed with BMPA-QD_{green}-coated colloids without BMPA-Fe₃O₄ nanoparticles (APS-SiO₂/(BMPA-QD_{green}/PAMA)₃)) in a nonpolar solvent. That is, the mass ratio of the magnetic luminescent colloids to the BMPA-QD_{green}-coated colloids was 1:1.

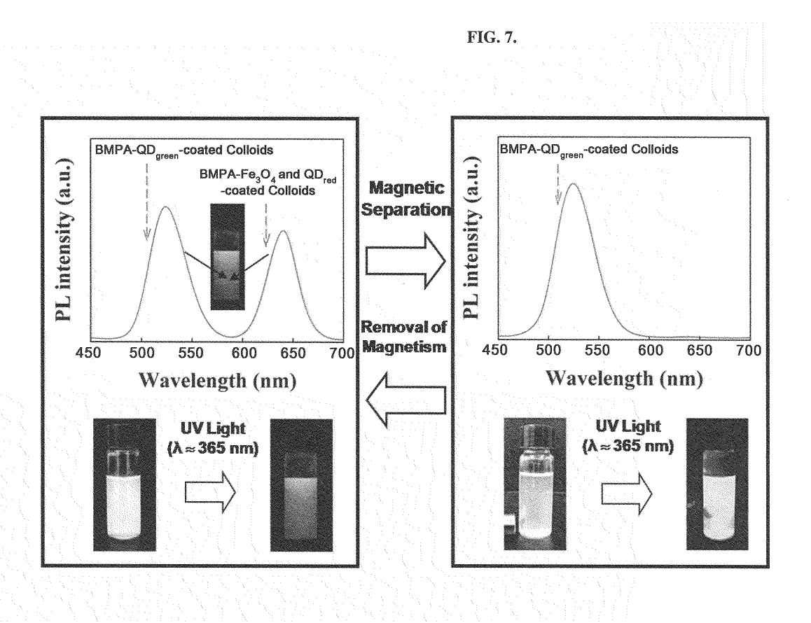

As shown in FIG. 7, the PL spectrum of the initial colloid solution showed two different PL peaks, λₘₐₓ=523 or 638 nm, originating from the BMPA-QD_{green} and BMPA-QD_{red}, respectively, without indication of energy transfer. When a magnet was placed close to the glass vial, the magnetic photoluminescent colloids that emitted in the red were quickly attracted to the magnet and accumulated near it within a few minutes. The remaining solution displayed green emission due to the dispersed BMPAQD_{green}-coated colloids without BMPA-Fe₃O₄, under UV light irradiation. The PL spectrum of the solution remaining after application of an external magnetic field did not display the red emission band in its spectrum. These results showed that the blending solution of photoluminescent colloids with and without BMPA-Fe₃O₄ can display reversible optically tuned properties under magnetic control in nonpolar solvent.

### Experimental Example 4

### Evaluation of Superhydrophobicity

Silica colloids densely coated with nanoparticles were deposited onto flat substrates, followed by introduction of fluoroalkylsilane, to prepare superhydrophobic surfaces with hierarchical dual roughness (micrometer-scale as well as nanometer-scale roughness). These superhydrophobic films also displayed optical and magnetic properties via the hydrophobic quantum dots and magnetic nanoparticles.

In the present invention, superhydrophobic films with nanometer-scale roughness that permit modulation of the water contact angle or UV light-driven optical properties were formed by the adsorption of multifunctional nanoparticles, which have not been described to date.

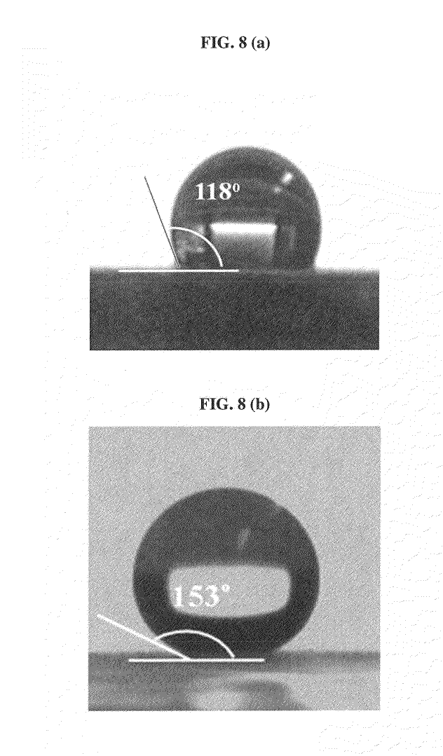

FIG. 8 shows the water contact angles of silica colloidal films with and without adsorbed BMPA-stabilized nanoparticles. The fluoroalkylsilane-coated colloidal films without nanoparticles yielded a water contact angle of 118°. On the other hand, colloidal films with BMPA-QD and Fe₃O₄ displayed a water contact angle exceeding 150°, in addition to its strong PL and magnetic properties. The hierarchical surface of a colloidal film prepared from BMPA-stabilized nanoparticles lies in the Cassie state in that Δθ_{ad-re} is smaller than 10°.

These results indicate that BMPA-stabilized nanoparticles could be used to form structural features that displayed superhydrophobicity in addition to the integrated functionalities of PL and superparamagnetism. The functional colloids were easily prepared by an NS reaction-based LbL assembly that facilitated adsorption of densely packed nanoparticles with retention of the inherent properties.

Multifunctional colloids coated with (PAMA/BMPA-CdSe/ZnS)ₙ multilayers could be successfully prepared using an NS reaction-based LbL assembly method in organic media. Coating of BMPA-Fe₃O₄ or PAMA as an outermost layer produced well-dispersed colloids in nonpolar solvents (toluene or hexane) or in polar organic solvents.

These colloids revealed strong magnetic and photoluminescent properties due to the presence of densely coated nanoparticles (BMPA-Fe₃O₄ and BMPA-CdSe/ZnS). The colloids additionally revealed high efficiency as a result of the crystal quality, functional stability, and dense coating of BMPA nanoparticles. The magnetic photoluminescent colloids provided reversible optical tuning memory under an external magnetic field. The highly protuberant and rugged surface morphology produced by the nanoparticle-coated colloids generated superhydrophobicity with a water contact angle exceeding 150°.

As is apparent from the foregoing, the multifunctional colloidal nanocomposite of the present invention has a highly dense multilayer structure in which BMPA-stabilized quantum dot nanoparticles and an amine-functionalized polymer are adsorbed onto silica colloids using a nucleophilic substitution reaction-based layer-by-layer assembly method. Due to this structure, the multifunctional colloidal nanocomposite of the present invention can be dispersed in various organic solvents. In addition, the multifunctional colloidal nanocomposite of the present invention can be utilized in various applications, such as nonvolatile memory devices, magnetic cards, and optical display films due to its strong magnetic and photoluminescent properties, high crystallinity and functional stability, and good superhydrophobicity.

What is claimed is:

1. A multifunctional colloidal nanocomposite comprising:
silica colloids coated with aminopropyltrimethoxysilane (APS); and
a plurality of nanoparticle layers highly densely adsorbed onto the APS-coated silica colloids,
wherein the nanoparticles are selected from 2-bromo-2-methylpropionic acid (BMPA)-stabilized quantum dot (BMPA-QD) particles, 2-bromo-2-methylpropionic acid (BMPA)-stabilized iron oxide (BMPA-Fe₃O₄) particles, poly(amidoamine) (PAMA) nanoparticles, and mixtures thereof, and
the nanoparticle layers have a laminate structure of (BMPA-Fe₃O₄/PAMA)ₙ, (BMPA-QD/PAMA)ₙ, (BMPA-QD/PAMA/BMPA-Fe₃O₄)ₙ, (BMPA-Fe₃O₄/PAMA/BMPA-QD)ₙ, (BMPA-QD/PAMA/BMPA-Fe₃O₄/PAMA)ₙ, or (BMPA-Fe₃O₄/PAMA/BMPA-QD/PAMA)ₙ, where n is an integer from 1 to 9, on the APS-coated silica colloids.

2. The multifunctional colloidal nanocomposite according to claim 1, wherein the quantum dot nanoparticles are nanoparticles of a CdSe/ZnS core-shell quantum dot compound.

3. A method for preparing a multifunctional colloidal nanocomposite, the method comprising:
(a) preparing silica colloids coated with aminopropyltrimethoxysilane (APS); and
(b) sequentially adsorbing a plurality of kinds of nanoparticles in high density onto the APS-coated silica colloids to form a plurality of nanoparticle layers,
wherein the nanoparticles are selected from 2-bromo-2-methylpropionic acid (BMPA)-stabilized quantum dot (BMPA-QD) particles, BMPA-stabilized iron oxide (BMPA-Fe₃O₄) particles, poly(amidoamine) (PAMA) nanoparticles, and mixtures thereof, and
the nanoparticle layers have a laminate structure of (BMPA-Fe₃O₄/PAMA)ₙ, (BMPA-QD/PAMA)ₙ, (BMPA-QD/PAMA/BMPA-Fe₃O₄)ₙ, (BMPA-Fe₃O₄/PAMA/BMPA-QD)ₙ, (BMPA-QD/PAMA/BMPA-Fe₃O₄/PAMA)ₙ or (BMPA-Fe₃O₄/PAMA/BMPA-QD/PAMA)ₙ, where n is an integer from 1 to 9, on the APS-coated silica colloids.

4. The method according to claim 3, wherein, in step (b), the nanoparticle layers are formed on the APS-coated silica colloids by layer-by-layer assembly based on a nucleophilic substitution reaction between the bromo groups of the 2-bromo-2-methylpropionic acid nanoparticles and the amine groups of the poly(amidoamine) to bond the 2-bromo-2-methylpropionic acid to the poly(amidoamine).

5. The method according to claim 3, wherein, in step (b), the plurality of nanoparticle layers are formed by layer-by-layer assembly based on a nucleophilic substitution reaction between the bromo groups of the 2-bromo-2-methylpropionic acid nanoparticles and the amine groups of the poly(amidoamine) to bond and adsorb the 2-bromo-2-methylpropionic acid to the poly(amidoamine).

6. The method according to claim 3, wherein, in step (b), the BMPA-QD or BMPA-Fe₃O₄ nanoparticles are dispersed in toluene as a solvent and adsorbed to the APS-coated silica colloids to form a BMPA-QD or BMPA-Fe₃O₄ nanoparticle layer on the APS-coated silica colloids.

7. The method according to claim 3, wherein, in step (b), the PAMA nanoparticles are dispersed in ethanol and adsorbed to the BMPA-QD or BMPA-Fe₃O₄ nanoparticle layer to form a PAMA nanoparticle layer.

8. The method according to claim 3, further comprising (c) dipping the APS-coated silica colloids formed with the plurality of nanoparticle layers thereon in a mixed solution of perfluorotrichlorosilane and hexane.
